(19) United States
(12) Patent Application Publication
(10) Pub. No.: US 2024/0211736 A1
(43) Pub. Date: Jun. 27, 2024

(54) METHOD AND APPARATUS FOR INFERRING SEMICONDUCTOR MEASUREMENT RESULTS BASED ON ARTIFICIAL INTELLIGENCE

(71) Applicant: SAMSUNG ELECTRONICS CO., LTD., SUWON-SI (KR)

(72) Inventors: Minchul Park, Suwon-si (KR); Satbyul Kim, Suwon-si (KR); Seongryeol Kim, Suwon-si (KR); Younggu Kim, Suwon-si (KR); Yeji Kim, Suwon-si (KR); Hyunjae Jang, Suwon-si (KR); In Huh, Suwon-si (KR)

(21) Appl. No.: 18/542,890

(22) Filed: Dec. 18, 2023

(30) Foreign Application Priority Data
Dec. 21, 2022 (KR) 10-2022-0180892

(51) Int. Cl. G06N 3/0464; G06F 11/00; G06N 3/08

(52) U.S. Cl. CPC G06N 3/0464; G06F 11/004; G06N 3/08; G06F 2201/86

(57) ABSTRACT

Provided are an apparatus and a method of inferring semiconductor measurement results. The method of inferring semiconductor measurement results is based on artificial intelligence techniques and includes receiving layout data representing a layout of a semiconductor, generating a plurality of partial layouts based on the layout data, selecting a representative partial layout among the plurality of partial layouts, and generating, using a machine learning model, a predicted measurement result for the semiconductor based on the representative partial layout.

### CROSS-REFERENCE TO RELATED APPLICATION

This application is based on and claims priority under 35 U.S.C. § 119 to Korean Patent Application No. 10-2022-0180892, filed on Dec. 21, 2022, in the Korean Intellectual Property Office, the contents of which are incorporated by reference herein in their entirety.

### TECHNICAL FIELD

The present disclosure relates to an electronic apparatus, and particularly to an electronic apparatus and a method of inferring semiconductor pattern measurement results based on artificial intelligence.

### DISCUSSION OF THE RELATED ART

Semiconductor process control is a process of measuring whether semiconductor manufacturing is successful. In some cases, semiconductor process control may include inspecting defects that occur during semiconductor processing. Defects that occur during semiconductor processing may affect product development and production. As the density of semiconductors increases and processes are subdivided, the current measurement methods can inspect less than 0.1% of the semiconductor layout.

Additionally, since structural variation occurs even in the same pattern, probability distribution modeling of expected measurement results from scanning electron microscope (SEM) image may be required to predict the quality and performance of the semiconductors, e.g., results of measurement from SEM image may be used to detect defects in ppm units. Therefore, there is a need in the art for systems and methods for predicting and inferring measurement results. Additionally, a method for predicting and verifying an expected weak point in the semiconductor layout as a result of the process may be needed.

### SUMMARY

The present disclosure describes an apparatus and a method for inferring measurement results of patterns in a semiconductor based on artificial intelligence. An embodiment of the present disclosure includes a method for inferring an expected weak point as a result of the measurement inferring process.

According to an aspect of the present disclosure, there is provided a method including receiving layout data representing a layout of a semiconductor, generating a plurality of partial layouts based on the layout data, selecting a representative partial layout among the plurality of partial layouts, and generating, using a machine learning model, a predicted measurement result for the semiconductor based on the representative partial layout.

According to another aspect of the present disclosure, there is provided an apparatus including: at least one processor, and memory storing instructions that, when executed by the at least one processor, cause the at least one processor to execute a process of inferring semiconductor measurement results, wherein the processor may receive layout data representing a layout of a semiconductor, generate a plurality of partial layouts based on the layout data, select a representative partial layout among the plurality of partial layouts, and generate, using a machine learning model, a predicted measurement result for the semiconductor based on the representative partial layout.

According to another aspect of the inventive concept, there is provided a non-transitory storage medium storing instructions that, when executed by at least one processor, cause the at least one processor to execute a method of inferring semiconductor measurement results, the method including receiving layout data representing a layout of a semiconductor, generating a plurality of partial layouts based on the layout data, selecting a representative partial layout among the plurality of partial layouts, and generating, using a machine learning model, a predicted measurement result for the semiconductor based on the representative partial layout.

Other features and aspects will be apparent from the following detailed description, the drawings, and the claims.

### BRIEF DESCRIPTION OF THE DRAWINGS

Embodiments will be more clearly understood from the following detailed description taken in conjunction with the accompanying drawings:

FIG. 1 is a flowchart showing a method of inferring semiconductor measurement results based on artificial intelligence, according to some embodiments;

FIG. 2 is a diagram showing a conversion process of layout data according to the aspects of FIG. 1;

FIG. 3 is a flowchart showing a method of training an artificial intelligence model using learning data according to some embodiments;

FIG. 4 is a block diagram showing a conversion process of learning data according to the training the artificial intelligence model using learning data of FIG. 3;

FIG. 5A is a diagram showing size conversion among layout conversions according to some embodiments;

FIG. 5B is a diagram showing rotation conversion among layout conversions according to some embodiments;

FIG. 6A is a diagram of providing a probability distribution of an SEM image by inferring measurement results according to some embodiments;

FIG. 6B is a diagram showing various SEM images that may be created in a single layout according to some embodiments;

FIG. 7 is a diagram for providing a weak point of a semiconductor by inferring measurement results according to some embodiments;

FIG. 8A is a graph showing a pattern distribution of critical dimensions for indicating a risk index of the critical dimensions according to some embodiments;

FIG. 8B is a graph showing an average distribution of critical dimensions for indicating a risk index of the critical dimensions according to some embodiments;

FIG. 8C is a graph showing a standard deviation distribution of critical dimensions for indicating a risk index of the critical dimensions according to some embodiments;

FIG. 9A is a diagram showing a process of matching learning data according to some embodiments onto a latent space of artificial intelligence;

FIG. 9B is a block diagram showing a process of optimizing a loss function by matching learning data according to some embodiments;

FIG. 10 is a block diagram showing a process of training an artificial intelligence model based on multimodal deep learning according to some embodiments;

FIG. 11A is a diagram showing an inspection apparatus for semiconductor process control according to a comparative example;

FIG. 11B is a diagram showing an inspection apparatus for semiconductor process control according to some embodiments of the present disclosure;

FIG. 12A is a diagram showing a review apparatus for semiconductor process control according to a comparative example;

FIG. 12B is a diagram showing a review apparatus for semiconductor process control according to some embodiments of the present disclosure; and

FIG. 13 is a block diagram showing an apparatus for inferring semiconductor measurement results according to some embodiments.

### DETAILED DESCRIPTION

Embodiments of the present disclosure include a method for semiconductor process control based on artificial intelligence. Some embodiments of the disclosure include a method for identifying defects that occur during semiconductor processing. In some cases, artificial intelligence is used to infer measurements of semiconductor patterns. An embodiment of the present disclosure includes a method for inferring an expected weak point as a result of the measurement inferring process.

Conventional methods of semiconductor process control may inspect defects for semiconductors that have low density. However, as the density of semiconductors increases and processes are subdivided, the conventional measurement methods cover less than 0.1% of the semiconductor process control. As such, conventional methods may not be able to successfully predict and infer measurement results leading to defects that can adversely affect product development and production.

Accordingly, embodiments of the present disclosure include systems and methods to infer the measurement results of the patterns in the semiconductor. In some cases, as a result of the measurement results, expected weak points may also be inferred. One or more embodiments of the present disclosure include segmenting the entire layout of the semiconductor, performing the layout conversion process, and predicting the measurement results for all patterns through artificial intelligence.

According to an embodiment of the present disclosure, critical dimension measurement may be performed for selected points on the layout of the semiconductor. In some cases, an artificial intelligence model may predict a weak point which is a point with a risk index above a certain value using a risk index of the critical dimension, which is the expected measurement result of the critical dimension. Additionally, SEM measurement may be performed for selected points on the layout of the semiconductor. Accordingly, the artificial intelligence model may predict an SEM measurement result using a representative image or probability distribution of SEM images, which is an expected SEM measurement result.

According to some embodiments of the present disclosure, the artificial intelligence model may receive position information for a wafer and semiconductor. In some cases, a convolutional neural network or a loss function may be utilized during the training process of the artificial intelligence model. One or more embodiments of the disclosure include detection of a weak point in the semiconductor based on a risk index of the critical dimension. For example, the risk index of the critical dimension may be calculated based on a standard deviation of the critical dimension, an average value of the critical dimension, and the like.

Embodiments of the present disclosure include a method for inferring semiconductor measurement results based on artificial intelligence. The method includes receiving layout data representing a layout of a semiconductor and generating a plurality of partial layouts based on the layout data. In some cases, a representative partial layout is selected among the plurality of partial layouts. Finally, a predicted measurement result for the semiconductor is generated using a machine learning model based on the representative partial layout.

Accordingly, by inferring the measurement results of patterns in the semiconductor and the expected weak points based on segmenting the entire layout of the semiconductor, the artificial neural network based model can successfully predict defects and verify expected weak points as a result of the measurement process. Thus, by predicting defects that occur during semiconductor processing, embodiments of the present disclosure can improve product development and production.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. The features described herein may be embodied in different forms and are not to be construed as being limited to the example embodiments described herein. Rather, the example embodiments described herein have been provided merely to illustrate some of the many possible ways of implementing the methods, apparatuses, and/or systems described herein that will be apparent after an understanding of the disclosure of this application.

The present disclosure may be modified in multiple alternate forms, and thus specific embodiments will be exemplified in the drawings and described in detail. In the present specification, when a component (or a region, a layer, a portion, etc.) is referred to as being “on,” “connected to,” or “coupled to” another component, it means that the component may be directly disposed on/connected to/coupled to the other component, or that a third component may be disposed therebetween.

Like reference numerals may refer to like components throughout the specification and the drawings. It is noted that while the drawings are intended to illustrate actual relative dimensions of a particular embodiment of the specification, the present disclosure is not necessarily limited to the embodiments shown. The term “and/or” includes all combinations of one or more of which associated configurations may define.

It will be understood that, although the terms “first,” “second,” etc. may be used herein to describe various components, these components should not necessarily be limited by these terms. These terms are only used to distinguish one component from another. For example, a first component could be termed a second component, and, similarly, a second component could be termed a first component, without departing from the scope of the inventive concept. The terms of a singular form may include plural forms unless the context clearly indicates otherwise.

Additionally, terms such as “below,” “under,” “on,” and “above” may be used to describe the relationship between components illustrated in the figures. The terms are used as a relative concept and are described with reference to the direction indicated in the drawings. It should be understood that the terms “comprise,” “include,” or “have” are intended to specify the presence of stated features, integers, steps, operations, components, parts, or combinations thereof in the disclosure, but do not preclude the presence or addition of one or more other features, integers, steps, operations, components, parts, or combinations thereof.

Hereinafter, a method for semiconductor process control of an embodiment of the present disclosure will be described in detail with reference to the accompanying drawings, wherein an artificial neural network is used to infer measurement results of patterns in a semiconductor. The same reference numerals are used for the same components in the drawings, and duplicate descriptions thereof are omitted.

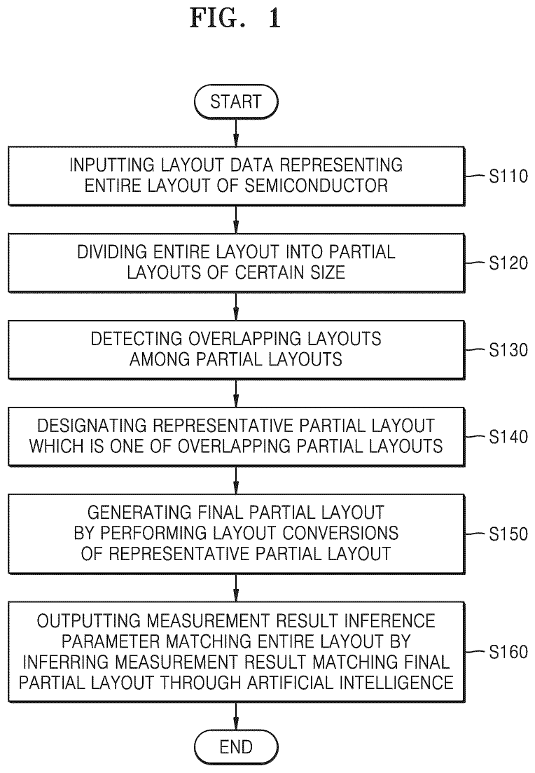

FIG. 1 is a flowchart showing a method of inferring semiconductor measurement results based on artificial intelligence, according to some embodiments.

Referring to FIG. 1, a method of inferring semiconductor measurement results may be based on artificial intelligence. The method of inferring semiconductor measurement results based on artificial intelligence may include a plurality of processes, i.e., S110, S120, S130, S140, S150, and S160.

Artificial intelligence may include machine learning including deep learning and rule-based AI. Deep learning may utilize an artificial neural network model. Deep learning may also utilize a convolutional neural network model.

An artificial neural network (ANN) is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

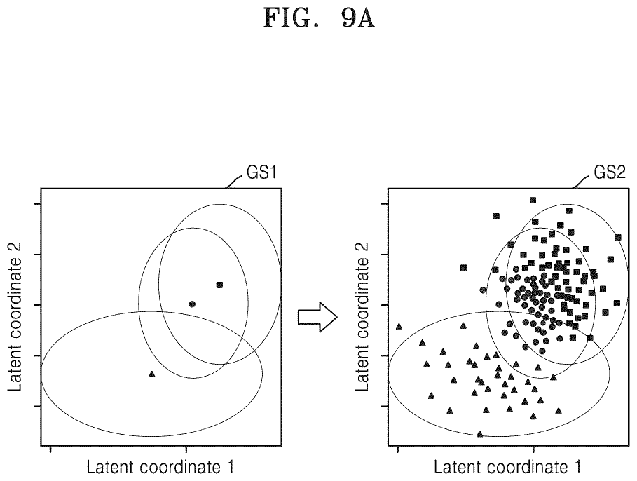

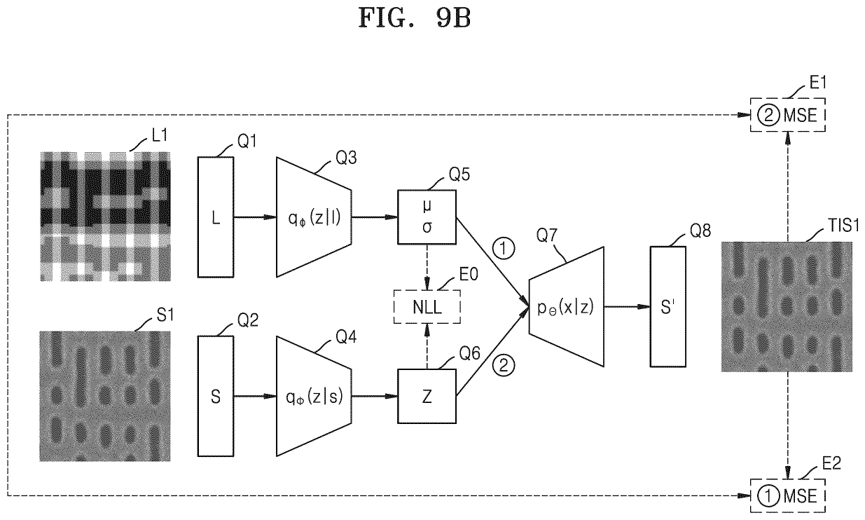

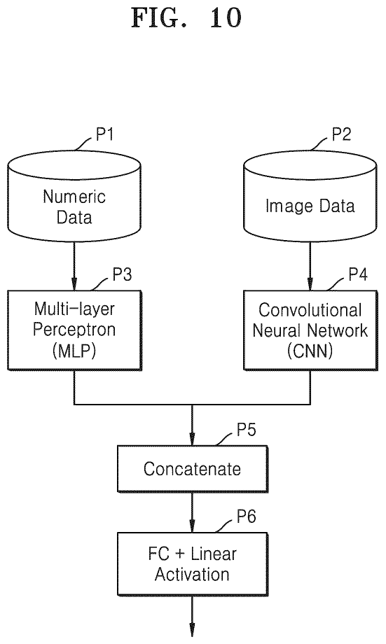

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times. A process for training an artificial intelligence based model, according to the present disclosure, is described with reference to FIGS. 9 and 10.

A CNN is a class of ANN that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

The semiconductor measurement results may include scanning electron microscope (SEM) images measured using an SEM. A scanning electron microscope (SEM) is a subset of electron microscopes that produces images of a sample by scanning the surface with a focused beam of electrons of relatively low energy as an electron probe that is scanned in a regular manner over the specimen. The electrons interact with atoms in the sample, producing various signals that contain information about the surface topography and composition of the sample.

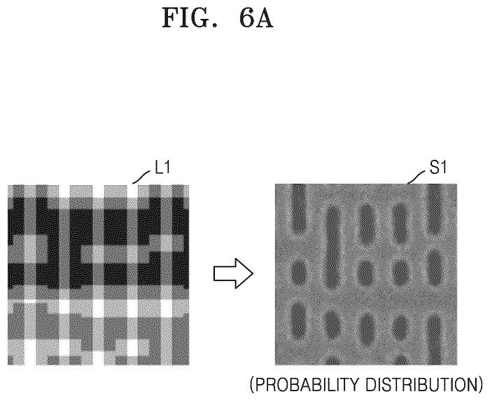

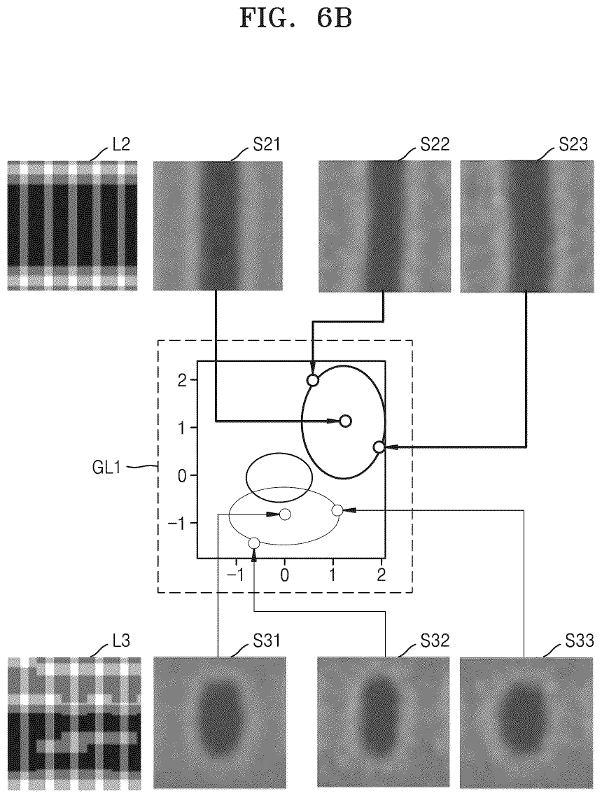

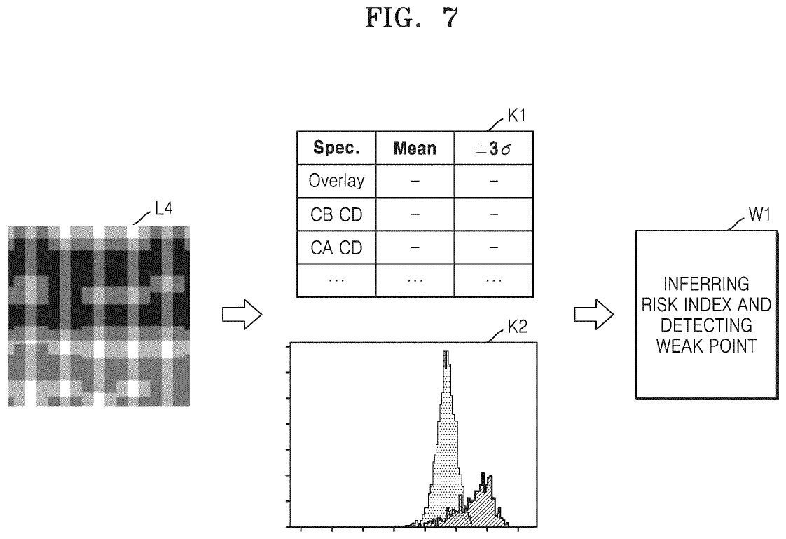

In some cases, the semiconductor measurement results from the SEM may include size measurement or spacing measurement of critical dimensions inside the semiconductor layout. The critical dimension may refer to a line width or a spacing between lines of the semiconductor layout. As an example, the semiconductor measurement results may include measurement for detecting a weak point or a risk index of the semiconductor. The semiconductor measurement results are described with reference to FIGS. 6 and 7.

The method of inferring semiconductor measurement results may provide virtual measurement results based on inferring measurement results for a part of the semiconductor that has not been measured, and may infer measurement results through artificial intelligence. In an embodiment, the method of inferring semiconductor measurement results may be trained to learn the matching relationship between the layout and the matching measurement results using the given learning data, and infer the measurement results matching the given layout. A measurement result inference parameter for deriving artificial intelligence modeling and inference results is described below.

In S110, an artificial intelligence model may receive layout data representing the entire layout of the semiconductor. The artificial intelligence model may process computations using artificial intelligence. In the artificial intelligence model, computations may be performed internally or may be performed externally to receive output values. The layout of the semiconductor may refer to a physical pattern of a semiconductor circuit implemented on a semiconductor integrated circuit, i.e., an arrangement of transistors and wires therebetween, indicated as two-dimensional figure information. The layout may be provided as three-dimensional information. The layout data which is a data value representing the entire layout may be provided in the form of image data or data obtained by digitizing an image.

In some cases, input data may not be limited to layout data. According to an exemplary embodiment, input data may include wafer position data and semiconductor position data in addition to the layout data. The wafer position data may refer to data including a layout position on a wafer. The semiconductor position data may refer to data including a layout position on a semiconductor. Even though the same pattern is designed within the layout, the layout pattern may be manufactured differently in a process according to a position within a wafer or a position within a semiconductor. Additionally, the layout pattern is manufactured differently, so the tendency may appear differently during measurement. The artificial intelligence model may infer measurement results clearly by additionally receiving the wafer position data and the semiconductor position data.

In S120, the artificial intelligence model may divide the entire layout into partial layouts of certain size. The entire layout may include patterns, which are arrangement relationships or arrangement structures of overlapping and repeating internal conductive wires. The patterns may be arrangement relationships or arrangement structures of overlapping and repeating internal conductive wires. The artificial intelligence model may divide the entire layout into partial layouts of suitable size so that overlapping patterns are properly separated and internal patterns of the layout are easily analyzed. The partial layouts may be parts of the entire layout divided through a suitable division method. Additionally, the partial layouts may be of appropriate size and pattern for ease of analysis.

In S130, the artificial intelligence model may detect overlapping partial layouts among the partial layouts. As described above, multiple overlapping pattern structures and overlapping partial layouts among the partial layouts may exist within the layout. Accordingly, the artificial intelligence model may detect the overlapping partial layouts by inspecting whether the partial layouts overlap. In the process of inspecting whether the partial layouts overlap, the artificial intelligence model may utilize various overlapping pattern detection algorithms or overlapping image detection algorithms. Additionally, the artificial intelligence model may detect the overlapping layouts when the degree to which the partial layouts overlap is inspected and is equal to or greater than a certain predetermined value.

In S140, the artificial intelligence model may designate a representative partial layout that is one of the overlapping partial layouts. As described, multiple overlapping patterns among the partial layouts may exist. Accordingly, when measurement results are inferred by designating the representative partial layout among the overlapping partial layouts, the artificial intelligence model may prevent unnecessary repetition of overlapping parts. A series of the overlapping partial layouts may exist in multiple sets (i.e., more than one set). Accordingly, a plurality of representative partial layouts each representing a set of overlapping partial layouts may exist. The artificial intelligence model may designate a partial layout with no overlapping layout as a representative partial layout.

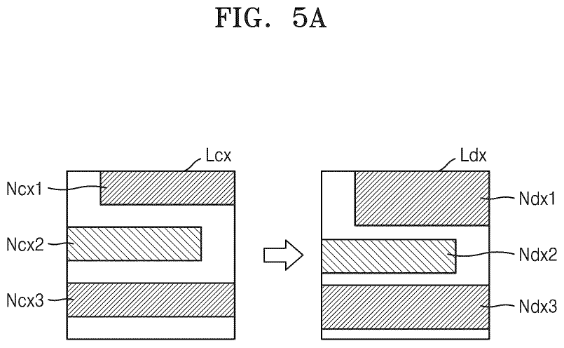

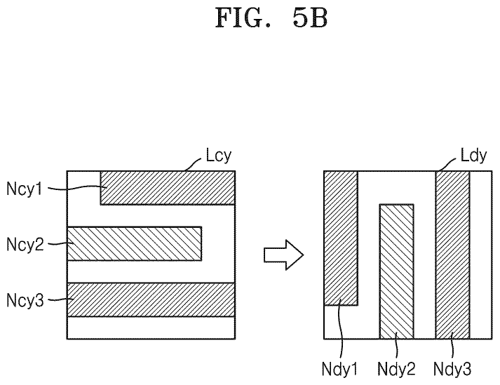

In S150, the artificial intelligence model may generate a final partial layout by performing layout conversions of the representative partial layout. The layout conversions may refer to a process of preprocessing layout patterns so that the layout patterns match the artificial intelligence model before inferring measurement results of the layout patterns. A sample layout of the learning data may be different from patterns of the input layout. Accordingly, the artificial intelligence model may perform layout conversions to match the sample layout patterns. The artificial intelligence model generated based on the learning data as a result of layout conversions may accurately predict the measurement results of the input layout. In some cases, the layout conversions may include size conversion or rotation conversion. In some cases, the layout conversions may include both - size conversion and rotation conversion. An example of a layout conversion is described with reference to FIG. 5.

In S160, the artificial intelligence model may output a measurement result inference parameter matching the entire layout by inferring the measurement results matching the final partial layout. As described, the semiconductor measurement results may include an SEM image, or may include size measurement or spacing measurement of critical dimensions. Additionally, the semiconductor measurement results may include measurement for detecting a weak point or a risk index. The artificial intelligence model may infer measurement results matching the final partial layout, where layout conversions are completed based on an artificial intelligence algorithm.

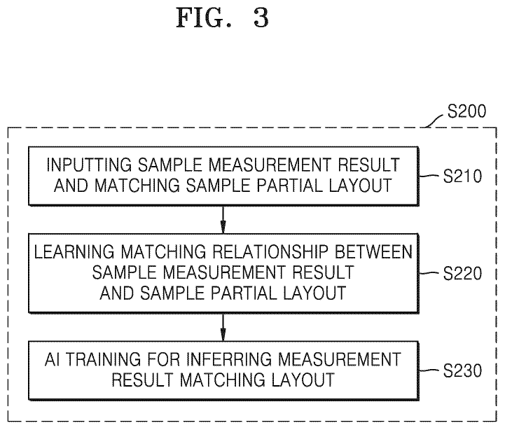

As described with reference to FIG. 3, the artificial intelligence model may be trained by learning data to infer measurement results. In some cases, the artificial intelligence model may infer measurement results matching the final partial layout, and based thereon, a measurement result inference parameter matching the entire layout may be generated. As described, when the input data includes layout data, wafer position data, and semiconductor position data, the artificial intelligence model may infer measurement results matching the final partial layout, the wafer position data of the final partial layout, and the semiconductor position data of the final partial layout to generate the measurement result inference parameter. The measurement result inference parameter may be provided as a definite value or as a probability distribution. As an example, the measurement result inference parameter may include an SEM image or a probability distribution of the SEM image. As another example, the measurement result inference parameter may include a weak point or a risk index of critical dimensions. According to the embodiment described above, the artificial intelligence model may provide an effect of inferring measurement results of patterns in a semiconductor. Additionally, the artificial intelligence model may provide an effect of inferring an expected weak point as a result of the process.

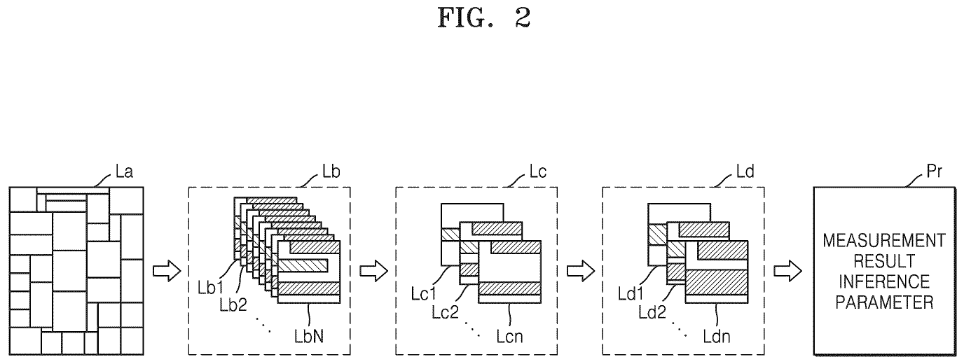

FIG. 2 is a diagram showing a conversion process of layout data in the method for inferring semiconductor measurement results of FIG. 1.

Referring to FIG. 2, as the method for inferring semiconductor measurement results is executed, the input layout data may be output as a measurement result inference parameter through the conversion process. Hereinafter, FIG. 2 is described with reference to FIG. 1.

When step S110 is performed, layout data La representing the entire layout may be input to the artificial intelligence model.

As step S120 is performed, the input layout data La may be divided into partial layouts Lb of certain size. The partial layouts Lb may include a plurality of partial layouts including a first partial layout Lb1, a second partial layout Lb2, an n^{th} partial layout LbN, and the like.

As steps S130 and S140 are performed, overlapping patterns may be removed from the partial layouts Lb to form representative partial layouts Lc. The representative partial layouts Lc may include a set of a plurality of representative partial layouts including a first representative partial layout Lc1, a second representative partial layout Lc2, an n^{th} representative partial layout LcN, and the like. As described above, a series of the overlapping partial layouts may exist in multiple sets (i.e., the series of the overlapping partial layouts may exist in not just one set). Accordingly, the plurality of representative partial layouts each representing the set of overlapping partial layouts may exist.

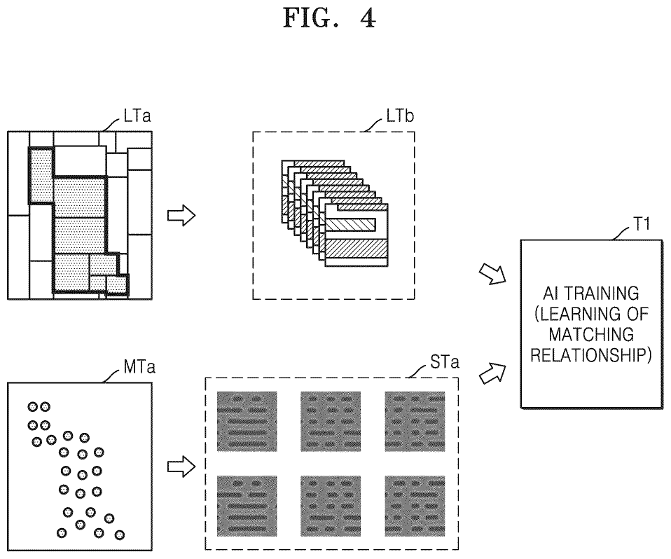

As step S150 is performed, the representative partial layouts Lc may be changed to final partial layouts Ld after layout conversions of the representative layouts Lc are performed. The layout conversions may include internal size conversion or rotation conversion of a partial layout. Thus, the final partial layouts Ld may also include a set of a plurality of final partial layouts including a first final partial layout Ld1, a second final partial layout Ld2, and an n^{th} final partial layout LdN, and the like. An example of performing a size conversion and a rotation conversion may be described with reference to FIGS. 4-5.

As step S160 is performed, the measurement results matching the final partial layouts Ld may be inferred through artificial intelligence, and the measurement result inference parameter Pr matching the entire layout may be output.

FIG. 3 is a flowchart showing a method of modeling artificial intelligence using learning data according to some embodiments.

Referring to FIG. 3, the method of training an artificial intelligence model using learning data may include a plurality of processes S210, S220, and S230.

The learning data may refer to data for training and modeling an artificial intelligence model. In some embodiments, the learning data may include sample partial layouts and sample measurement results. The sample partial layout may be a part of a layout measured by an actual inspection apparatus. The sample measurement results may refer to measurement results of the sample partial layouts. The method of training the artificial intelligence model may refer to a process of learning a matching relationship between measurement objects and measurement results to infer the expected measurement results of a given object.

Accordingly, in step S210, the artificial intelligence model may receive sample measurement results and sample partial layouts matching the sample measurement results. Since the sample layouts and sample measurement results are based on actual measurement results, the sample layouts and sample measurement results may be measurement results for a part of the entire layout of the semiconductor. The learning data is not limited to the sample partial layouts and sample measurement results. According to some embodiments, the learning data may include sample measurement results, sample partial layouts, sample wafer position data, and sample semiconductor position data. The sample partial layouts may match the sample measurement results. The sample wafer position data may match the sample measurement results. The sample semiconductor position data may match the sample measurement results.

In step S220, the artificial intelligence model may learn a matching relationship between the sample partial layouts and the sample measurement results. The sample partial layouts and sample measurement results may be based on actual measurement results. Accordingly, the artificial intelligence model may receive measurement results of given layout patterns and learn the tendency or matching relationship of measurement. Additionally, as described, even though the same pattern is designed within the layouts, the layout pattern may be manufactured differently in a process according to a position within a wafer or a position within a semiconductor. The artificial intelligence model may learn the matching relationship between measurement objects and measurement results when additionally receiving sample wafer position data and sample semiconductor position data.

In step S230, the artificial intelligence model may be trained to infer the measurement results matching the entire layout given as an input. When layout data to be analyzed is provided, the artificial intelligence model may be trained to infer the matching measurement results (e.g., even though measurement data is not provided). During the process of training the artificial intelligence model, the matching relationship between learning data learned in step S220 may be used. Additionally, the sample wafer position data and the sample semiconductor position data may be received and learned. Therefore, the artificial intelligence model may be trained to infer measurement results matching the entire layout, the wafer position data, and the semiconductor position data. An embodiment describing a process of training an artificial intelligence model by learning a matching relationship between learning data is described with reference to FIGS. 9A, 9B, and 10.

FIG. 4 is a block diagram showing a conversion process of learning data according to the training of the artificial intelligence model using learning data of FIG. 3.

Referring to FIG. 4, in the process of training of the artificial intelligence model, learning data is used to learn a matching relationship through a conversion process. Hereinafter, FIG. 4 is described with reference to FIG. 3.

Since the learning data is based on actual measurement results, a part of the entire layout of the semiconductor may be measured to be used as sample data. To generate the learning data, a part of the sample entire layout LTa may be measured. The sample entire layout LTa may be an entire layout selected as a sample. The sample measurement position MTa may indicate a position of a part where measurement is performed in the sample entire layout LTa. The sample measurement position MTa may indicate a part where measurement is performed. A sample measurement result STa may be generated by measuring the sample entire layout LTa at the sample measurement position MTa. Additionally, the sample partial layouts LTb of the sample entire layout LTa may be generated by selecting partial layouts matching the sample measurement results STa.

When step S210 is performed, the sample measurement results STa and the sample partial layouts LTb matched thereto may be input to the artificial intelligence model. When step S220 is performed, the input sample measurement results STa and the sample partial layouts LTb are input into the artificial intelligence model and may be used for learning the matching relationship. When step S230 is performed, the artificial intelligence model may perform artificial intelligence training (T1) by learning the matching relationship. Additionally, the artificial intelligence model may be trained by receiving the sample wafer position data and the sample semiconductor position data. The artificial intelligence model may obtain the wafer position data and the semiconductor position data from the sample measurement position MTa. In addition, the artificial intelligence model may be trained to infer measurement results matching the entire layout, the wafer position data, and the semiconductor position data.

FIG. 5A is a diagram showing size conversion among layout conversions according to some embodiments. FIG. 5B is a diagram showing rotation conversion among layout conversions according to some embodiments.

Hereinafter, FIGS. 5A and 5B are described with reference to FIG. 1. Referring to FIG. 5A, the layout conversion may include size conversion. The size conversion may include conversion of the critical dimension or pattern spacing within the layout. When S150 is performed, the artificial intelligence model may perform size conversion of the representative partial layout Lcx to generate the final partial layout Ldx where the size conversion is performed. The representative partial layout Lcx may include internal wires therein, such as a first size wire Ncx1, a second size wire Ncx2, a third size wire Ncx3, and the like. As the size conversion is performed, the first size wire Ncx1, the second size wire Ncx2, and the third size wire Ncx3 may be changed into a first size conversion wire Ndx1, a second size conversion wire Ndx2, and a third size conversion wire Ndx3 because the spacing, the line width, etc. thereof are changed. For example, when the line width of the sample partial layout provided as the learning data is larger than the line width of the representative partial layout Lcx of the input data, the size conversion may cause large conversion of the line width of the internal wires of the representative partial layout Lcx. As another example, when the line width of the sample partial layout provided as the learning data is smaller than the line width of the representative partial layout Lcx of the input data, the size conversion may cause small conversion of the line width of the internal wires of the representative partial layout Lcx to be smaller. The size conversion may increase the predictability of measurement results matching the input layout.

Referring to FIG. 5B, the layout conversion may include rotation conversion. The rotation conversion may refer to rotation of the layout by an integral multiple of 90 degrees, and by a distorted angle when the angle of the input partial layout is constantly distorted compared to the sample partial layout. When step S150 is performed, the artificial intelligence model may perform rotation conversion of the representative partial layout Lcy to generate the final partial layout Ldy where the rotation conversion is performed. The representative partial layout Lcy may include internal wires therein, including a first rotation wire Ncyl, a second rotation wire Ncy2, a third rotation wire Ncy3, and the like. As the rotation conversion is performed, the first rotation wire Ncy1, the second rotation wire Ncy2, and the third rotation wire Ncy3 may be changed into a first rotation conversion wire Ndy1, a second rotation conversion wire Ndy2, and a third rotation conversion wire Ndy3 because the spacing, line width, orientation, etc. thereof are changed. In an embodiment, the internal wires of the sample partial layout provided as learning data are arranged horizontally. In some cases, when the internal wires of the representative partial layout of the input data are arranged vertically, the rotation conversion may rotate the representative partial layout by 90 degrees and convert the representative partial layout such that the representative partial layout is arranged in the same wiring direction as the sample partial layout. The rotation conversion may increase the predictability of measurement results matching the input layout.

As described above, in step S160, the artificial intelligence model may output a measurement result inference parameter matching the entire layout by inferring measurement results matching the final partial layout. The representative partial layout where layout conversions are completed may cover layout patterns of the entire layout. Accordingly, the measurement result inference parameter may be output by inferring measurement results matching the entire layout. According to an embodiment, the artificial intelligence model may provide an effect of inferring measurement results of patterns in a semiconductor. Additionally, the artificial intelligence model may provide an effect of inferring an expected weak point as a result of the process.

FIG. 6A is a diagram of outputting an SEM image probability distribution by inferring measurement results according to some embodiments. FIG. 6B is a diagram showing various SEM images that may be created in a single layout according to some embodiments.

Referring to FIG. 6A, the semiconductor measurement result may be an SEM image measured using an SEM. The measurement result inference parameter S1 may include an SEM image probability distribution matching the input layout. Additionally, the measurement result inference parameter S1 may include a representative SEM image estimated from the SEM image probability distribution matching the input layout. According to an embodiment, when the representative partial layout L1 is input, a target semiconductor measurement result may be an SEM image. By using the SEM image through SEM measurement, it is possible to inspect whether the semiconductor production is well done as a result of semiconductor processing. Accordingly, the SEM image may be a target semiconductor measurement result. Additionally, since structural variation occurs even in the same pattern, the measurement result inference parameter S1 may include an SEM image probability distribution matching the input layout.

The artificial intelligence model training may be performed by learning a matching relationship between a sample SEM image as a sample measurement result of learning data and a sample partial layout matching the sample SEM image to output the SEM image probability distribution. The artificial intelligence model may be trained to infer the SEM image matching the entire layout provided as input in steps S220 and S230. Additionally, since there may be cases where the representative image itself is required, the representative SEM image may be output as a measurement result inference parameter in the SEM image probability distribution. For example, an SEM image matching an average value of the SEM image probability distribution may be output as a representative SEM image for parts other than an expected weak point. Additionally, for a layout near the expected weak point, an SEM image matching a value obtained by adding or subtracting an integral multiple of a standard deviation to or from the average value of the SEM image probability distribution may be output as a representative SEM image.

The artificial intelligence model may output an SEM image probability distribution matching the entire layout input as the measurement result inference parameter S1 or a representative SEM image estimated from the SEM image probability distribution. As a result, the artificial intelligence model may predict an SEM measurement result through a representative image or probability distribution of the SEM image, which is an expected SEM measurement result. In some cases, actual SEM measurement may not be performed for points of the entire layout of the semiconductor.

Referring to FIG. 6B, a variation of actual measurement result structure may occur even for partial layouts having the same pattern. Although the same pattern is designed within the layouts, the layout pattern may be manufactured differently due to the relative position within the semiconductor or various process variables during semiconductor processing. In the semiconductor layout, when SEM measurement is performed on several points having the same layout pattern as a first example partial layout L2, different measurement results of a first example SEM image S21, a second example SEM image S22, and a third example SEM image S23 may be derived. Additionally, when SEM measurement is performed on several points having the same layout pattern as a second example partial layout L3, different measurement results of a fourth example SEM image S31, a fifth example SEM image S32, and a sixth example SEM image S33 may be derived. As described below in detail with reference to FIG. 9, the layouts and the measurement results may be matched onto an internal latent space of the artificial intelligence model. In a first graph GL1, the first example SEM image S21, the second example SEM image S22, the third example SEM image S23, the fourth example SEM image S31, the fifth example SEM image S32, and the sixth example SEM image S33 may be matched onto the internal latent space of the artificial intelligence model. According to an embodiment, by matching the layouts and measurement results onto the latent space, the artificial intelligence model may provide an effect of inferring measurement results considering structural variation existing in the same pattern.

FIG. 7 is a diagram for providing a weak point of a semiconductor by inferring measurement results according to some embodiments.

Referring to FIG. 7, the semiconductor measurement result may include a critical dimension, which refers to a line width or line spacing of the semiconductor layout. The measurement result inference parameter W1 may include a weak point or a risk index of the semiconductor. According to an embodiment, when the representative partial layout L4 is input, a target semiconductor measurement result may be a critical dimension. The measurement of the critical dimensions may be performed using an optical critical dimension inspection apparatus or through SEM measurement. The measurement of the critical dimensions may be suitably performed using other inspection apparatuses. Through the measurement of the critical dimensions, it is possible to inspect whether the semiconductor production is suitably performed as a result of semiconductor processing. Through the measurement of the critical dimensions, it is also possible to inspect whether the line width or the line spacing of the wires located in the layout is appropriately formed.

As described, since structural variation occurs even in the same pattern, the measurement result inference parameter W1 may include a weakness point or a risk index of the semiconductor. For example, even though the critical dimensions of the same line width are designed, the line width may be formed differently as a result of actual measurement. Accordingly, there may be a weak point even where there is a possibility that the required circuit design operation is performed properly, such as when the line width of the wires is formed thinner than the required value (e.g., a predetermined value). The artificial intelligence model may show the distribution of the critical dimensions in a graph K2 by measuring the critical dimensions of wires in the input representative partial layout and the distribution thereof. Additionally, the artificial intelligence model may show an average value and a standard deviation of the critical dimensions of wires in a table K1. As described, in order to detect a weak point in the semiconductor, the risk index of the critical dimensions may be calculated based on the standard deviation of the critical dimensions, the average value of the critical dimensions, and the like. Additionally, the risk index of the critical dimensions may be calculated by considering an error such as a standard deviation of line edge roughness of the wires in the layout. For example, the risk index of the critical dimensions may be calculated by increasing or decreasing an integral multiple of the standard deviation of the critical dimensions from the average value of the critical dimensions, and increasing or decreasing an integral multiple of the standard deviation of the line edge roughness therefrom. The risk index of the critical dimensions according to an example may be calculated as in [Equation 1] below.

Short Risk Index=μ_{CD}−3σ_{CD}−3σ_{LER} [Equation 1]

Here, μ_{CD} is an average value of the critical dimensions, σ_{CD} is a standard deviation of the critical dimensions, and σ_{LER} is a standard deviation of the line edge roughness. Since the error in process or the structural variation may follow a Gaussian distribution, a value deviating from the average by three times the standard deviation may indicate that the error in process or the structural variation is within 0.3%. That is, the value of μ_{CD}−3σ_{CD} may be a predictable lower limit in which the designed critical dimension may be formed thinner than the required value due to an error in process.

Additionally, wires in the layout may not form a perfect plane, i.e., the wires may have a certain roughness. Therefore, the artificial intelligence model may calculate the risk index of the critical dimensions by subtracting three times the standard deviation of the line edge roughness (3σ_{LER}). The smaller the risk index value of the critical dimensions, the higher the probability that the conductive wires are produced thin. Accordingly, the artificial intelligence model may reflect the risk index of the wires in the semiconductor layout based on the risk index calculation. Additionally, the artificial intelligence model may set a point of the semiconductor having a critical dimension equal to or greater than a reference value as a weak point of the semiconductor. The reference value may vary depending on the target production value or yield. Additionally, the reference value may be adjusted based on defining the required weak point. The artificial intelligence model may receive, as sample measurement results among learning data, a sample critical dimension and a sample partial layout matching the sample critical dimension. Modeling of the artificial intelligence model may be performed through learning of a matching relationship between the sample critical dimension and the sample partial layout. As a result, the artificial intelligence model may be trained to detect the risk index or weak point of the critical dimensions with the measurement result inference parameter W1.

The artificial intelligence may be trained to infer the risk index of the critical dimensions matching the entire layout given as input in steps S220 and S230. Additionally, it is possible to provide the risk index or weak point of the critical dimensions matching the entire layout input as the measurement result inference parameter W1. According to an embodiment, although the actual critical dimension measurement is not performed for points of the entire layout of the semiconductor, the artificial intelligence model may provide an effect of predicting a weak point of the entire semiconductor using a risk index of the critical dimensions.

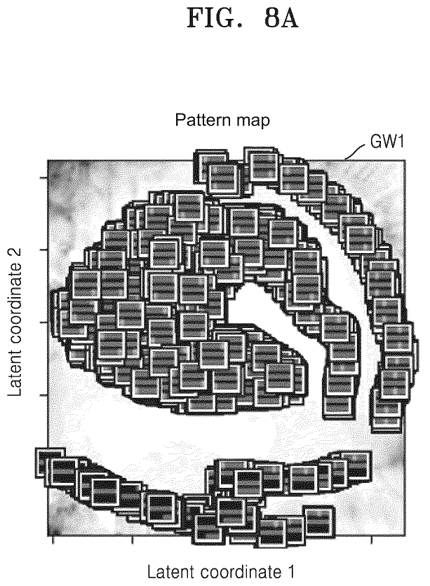

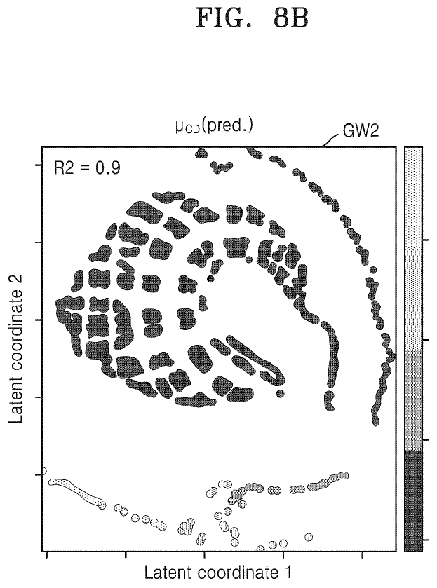

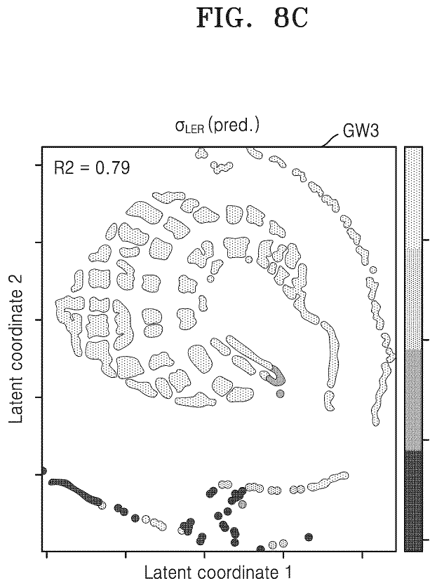

FIG. 8A is a graph showing a pattern distribution of critical dimensions for indicating a risk index of the critical dimensions according to some embodiments. FIG. 8B is a graph showing an average distribution of critical dimensions for indicating a risk index of the critical dimensions according to some embodiments. FIG. 8C is a graph showing a standard deviation distribution of critical dimensions for indicating a risk index of the critical dimensions according to some embodiments.

Referring to FIGS. 8A, 8B, and 8C, the artificial intelligence model may utilize a pattern distribution graph GW1 of the critical dimensions, an average value distribution graph GW2 of the critical dimensions, and a standard deviation distribution graph GW3 of the critical dimensions to infer the risk index distribution of the critical dimensions. Hereinafter, FIGS. 8A, 8B and 8C are described with reference to FIG. 7.

Referring to FIG. 8A, the artificial intelligence model may generate the pattern distribution graph GW1 on a latent space inside the artificial intelligence model. The pattern distribution graph GW1 may be a graph in which internal patterns of the representative partial layout are distributed. In addition, the pattern distribution graph GW1 may be a preprocessing process for analyzing the risk index or weak point of the critical dimensions.

Referring to FIG. 8B, the artificial intelligence model may generate the average value distribution graph GW2 on a latent space inside the artificial intelligence model. The average value distribution graph GW2 may be a graph in which average values of the critical dimensions of internal patterns are distributed.

Referring to FIG. 8C, the artificial intelligence model may generate the standard deviation distribution graph GW3 on a latent space inside the artificial intelligence model. The standard deviation distribution graph GW3 may be a graph in which standard deviations of the critical dimensions of internal patterns are distributed. The latent space of the artificial intelligence model is described with reference to FIG. 9.

The risk index of the critical dimensions may be calculated based on the mean value of the critical dimensions and the standard deviation of the critical dimensions. Therefore, the artificial intelligence model may show the position distribution of patterns on the latent space through the pattern distribution graph GW1. Additionally, the artificial intelligence model may indicate the risk index distribution of the critical dimensions based on the average value distribution graph GW2 and the standard deviation distribution graph GW3. In some cases, the actual critical dimension measurement is not performed for each point of the entire layout of the semiconductor. According to an embodiment, the artificial intelligence model may provide an effect of predicting the weak point by inferring the risk index distribution of the critical dimensions.

FIG. 9A is a diagram showing a process of matching learning data according to some embodiments onto a latent space of artificial intelligence. FIG. 9B is a block diagram showing a process of optimizing a loss function by matching learning data according to some embodiments.

Referring to FIGS. 9A and 9B, the artificial intelligence model may optimize a matching relationship by matching learning data to a latent space and defining a loss function based on learning data values. Hereinafter, FIGS. 9A and 9B are described with reference to FIG. 6.

Referring to FIG. 9A, the artificial intelligence model may receive the sample SEM image and the sample partial layout matching the sample SEM image as sample measurement results among learning data. The artificial intelligence model may match learning data onto the latent space of the artificial intelligence model. The latent space may be an embedding space including a set of elements existing in the manifold. Additionally, the latent space may be a virtual space newly formed from an actual observation space in the process of being reconstructed to explain target characteristic data among the input data. According to an embodiment, the latent space may be configured in a direction where dimensionality reduction is performed by excluding parts not necessary for analysis among the input data. That is, the latent space may have a smaller dimension than the actual observation space.

In some cases, noise removal or data compression may be performed on the latent space through dimensionality reduction and the latent space may be configured to facilitate data analysis. As described, even for one layout pattern, several SEM images may exist, and thus, variation of the SEM images may exist. One layout pattern may exist on the center of each ellipse in a first training graph GS1. A second training graph GS2 may indicate a distribution state of sample SEM images. The sample SEM images may be sample measurement results matching the layout patterns on the first training graph GS1. Through the first training graph GS1 and the second training graph GS2, sample partial layouts and sample SEM images matched thereto may be matched onto a latent space. The artificial intelligence training algorithm after matching is described with reference to FIG. 9B.

Referring to FIG. 9B, the matched sample partial layout L1 and the sample SEM image S1 matched thereto may be matched onto a latent space. Additionally, the artificial intelligence model may learn the matching relationship between the sample partial layout and the sample SEM image while being optimized in the direction of minimizing the loss function E0. As described with reference to FIG. 9A, the first data Q1 is matched onto the first training graph GS1 and may exist on the latent space in the form of third data Q3. The first data Q1 may be a value in which the sample partial layout L1 is stored in a data form. Additionally, the second data Q2 is matched onto the second training graph GS2 and may exist in the latent space in the form of fourth data Q4. The second data Q2 may be a value in which the sample SEM image S1 is stored in a data form. The loss function E0 may represent the degree to which the sample partial layout L1 and the sample SEM image S1 are matched onto the latent space. In order to calculate the loss function E0, the fifth data Q5 (i.e., a layout embedding) derived from the third data Q3 and the sixth data Q6 (i.e., a measurement embedding) derived from the fourth data Q4 may be used.

The fifth data Q5 and the sixth data Q6 may be basic data on a latent space for outputting an SEM image. Additionally, the fifth data Q5 and the sixth data Q6 may represent average or standard deviation values of the distribution of the sample partial layout L1 and the sample SEM image S1. From the fifth data Q5 and the sixth data Q6, seventh data Q7 for providing the SEM image probability distribution from the input layout may be generated. The seventh data Q7 may refer to data for providing the SEM image probability distribution from the input layout. When a layout to be analyzed is input, eighth data Q8, which refers to SEM image probability distribution data matching and input onto the seventh data Q7, may be output. Finally, the SEM image probability distribution TIS1 may be output as a measurement result inference parameter. Additionally, an SEM representative image based on the SEM image probability distribution TIS1 may be generated. The seventh data Q7 may be generated from the fifth data Q5 and the sixth data Q6. Therefore, a first mean square error E1 and a second mean square error E2, which are mean square errors in a process of matching the fifth data Q5 and the sixth data Q6 to the seventh data Q7, may be generated. It is possible to optimize the matching relationship of data on the latent space through the loss function E0, the first mean square error E1, and the second mean square error E2. According to an embodiment, by matching the layouts and measurement results onto the latent space, the artificial intelligence model may provide an effect of inferring measurement results considering structural variation existing in the same pattern.

FIG. 10 is a block diagram showing a process of training an artificial intelligence model based on multimodal deep learning according to some embodiments.

Referring to FIG. 10, the artificial intelligence model may be trained through multi-modal deep learning. Hereinafter, FIG. 10 is described with reference to FIG. 7.

Referring to FIG. 10, the artificial intelligence model may be trained using both numeric data P1 and image data P2 as learning data. The numeric data P1 may include a value, an average value, a standard deviation, or the like of the critical dimensions. In addition, the numeric data P1 may include a standard deviation of line edge roughness. As described, the input data may be layout data, wafer position data, semiconductor position data, or the like. Accordingly, the artificial intelligence model may be trained by additionally receiving sample wafer position data and sample semiconductor position data. In some examples, the numeric data P1 may include the sample wafer position data and the sample semiconductor position data. In some examples, the image data P2 may include a sample layout or a sample SEM image. The numeric data P1 may be input to a first artificial neural network P3 and the image data P2 may be input to a second artificial neural network P4.

According to some examples, the first artificial neural network P3 and the second artificial neural network P4 may be multi-layer perceptrons (MLP) or CNN. An MLP is a feed forward neural network that typically includes multiple layers of perceptrons. Each component perceptron layer may include an input layer, one or more hidden layers, and an output layer. Each node may include a nonlinear activation function. An MLP may be trained using backpropagation (i.e., computing the gradient of the loss function with respect to the parameters).

Additionally, the artificial neural network may be one of artificial neural networks used for other deep learning. A multimodal neural network P5 may be generated by connecting the first artificial neural network P3 and the second artificial neural network P4. By using both numeric data P1 and image data P2, the multimodal neural network P5 may perform multimodal deep learning. The multimodal neural network P5 may form a fully connected layer P6 through additional layers. The average value and standard deviation of the critical dimensions may be output through the fully connected layer P6. The risk index of the critical dimensions matching the layout may also be calculated through the fully connected layer P6. In some cases, the actual critical dimension measurement is not performed for all points on the entire layout of the semiconductor. According to an embodiment, the artificial intelligence model may predict a weak point of the entire semiconductor using a risk index of the critical dimensions.

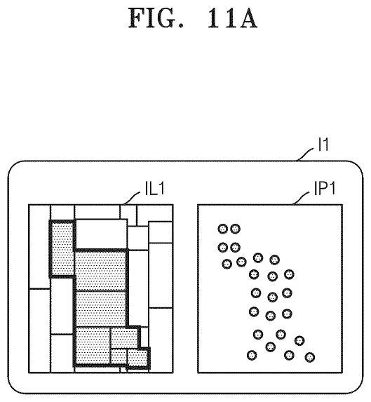

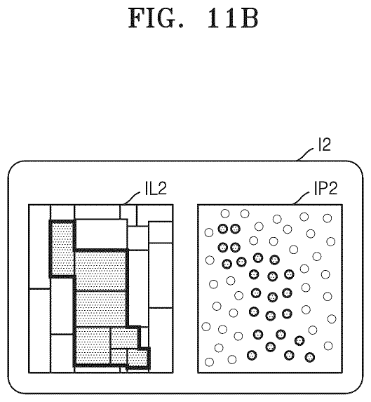

FIG. 11A is a diagram showing an inspection apparatus for semiconductor process control according to a comparative example. FIG. 11B is a diagram showing an inspection apparatus for semiconductor process control according to some embodiments of the present disclosure.

Referring to FIG. 11A, the conventional inspection apparatus I1 may be capable of measuring only a part of the entire layout. The conventional inspection apparatus I1 may be an inspection apparatus for semiconductor process control. For example, as the density of semiconductors increases and processes are subdivided, the current measurement may cover less than 0.1% of the semiconductor layout The conventional inspection apparatus I1 may be capable of measuring only the first measurement position IP1. The first measurement position IP1 may be a measurement position of a part of the first entire layout IL1. Thus, conventional inspection apparatus I1 can only measure a very small range of layout patterns.

Referring to FIG. 11B, the inspection apparatus I2, according to the aspects of the present disclosure, may cover the second entire layout and present a measurement result inference parameter matching each layout pattern. The inspection apparatus I2 may be an inspection apparatus for semiconductor process control according to some embodiments. According to the second measurement position IP2, the inspection apparatus I2 may present information on patterns of the entire layout by inferring the measurement position of a part and the measurement result of the other part. The second measurement position IP2 may indicate a measurement position of the second entire layout IL2. In case of the conventional inspection apparatus I1, only a very small range of layout patterns may be measured. However, measurement information matching the entire layout or the measurement result inference parameter may be provided by the inspection apparatus I2. Accordingly, the inspection apparatus I2 may cover the entire range of pattern measurement.

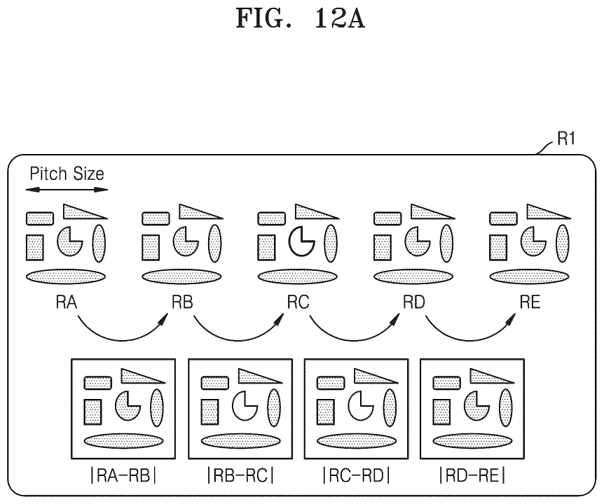

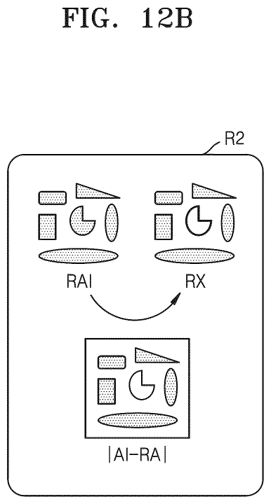

FIG. 12A is a diagram showing a review apparatus for semiconductor process control according to a comparative example. FIG. 12B is a diagram showing a review apparatus for semiconductor process control according to some embodiments of the present disclosure.

Referring to FIG. 12A, the conventional review apparatus R1 may be capable of reviewing only a part of the entire layout. The conventional review apparatus R1 may be a review apparatus for semiconductor process control. The semiconductor review apparatus may measure and analyze an actual weak point or how the measured part is produced differently and what kind of errors occur. The conventional review apparatus R1 may need to measure and compare several partial layouts having the same pattern to review an error at a specific point and the like. In some cases, after performing first partial layout review RA, second partial layout review RB, third partial layout review RC, fourth partial layout review RD, and fifth partial layout review RE, the conventional review apparatus R1 may detect a defect by calculating a difference between adjacent partial layout reviews. The conventional review apparatus R1 may calculate the difference between the first partial layout review RA and the second partial layout review RB images, the difference between the second partial layout review RB and the third partial layout review RC images, the difference between the third partial layout review RC and the fourth partial layout review RD images, the difference between the fourth partial layout review RD and the fifth partial layout review RE images. For example, as a result of the calculation, the conventional review apparatus R1 may derive the fact that a defect exists in the third partial layout review RC as a review result. Accordingly, the review method of the conventional review apparatus R1 may need a lot of analysis for review, thus, conventional review apparatus R1 can only review a very small range of layout patterns among the entire layout.

Referring to FIG. 12B, the present review apparatus R2, according to embodiments of the disclosure, may review more partial layouts than conventional review apparatus R1. The present review apparatus R2 may measure the target partial layout RX of a target point to review an error and the like at a specific point. Additionally, the present review apparatus R2 may output a measurement result inference parameter RAI matching the target partial layout. The present review apparatus R2 may derive whether the target partial layout RX is defective by comparing the measurement result of the target partial layout RX with the measurement result inference parameter RAI. In some cases, the amount of computational resources used by the present review apparatus R2 may be reduced. Additionally, the present review apparatus R2 may review more partial layouts (and thus, more points) than conventional review apparatus R1.

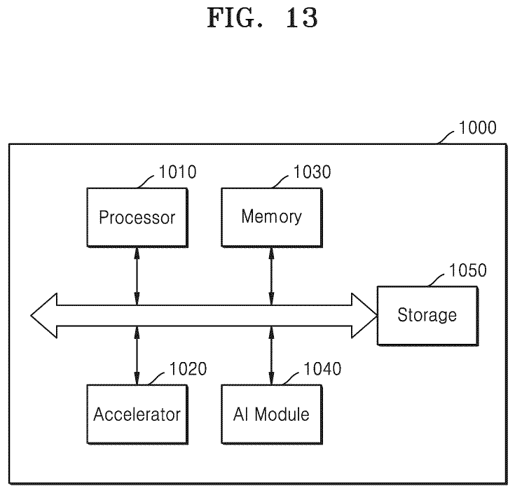

FIG. 13 is a block diagram showing an apparatus for inferring semiconductor measurement results according to some embodiments.

According to some embodiments, semiconductor measurement result inference may be executed in an apparatus 1000. The apparatus 1000 may include an artificial intelligence model (e.g., as described with reference to FIGS. 1-3).

Referring to FIG. 13, the apparatus 1000 may include at least one processor 1010, an accelerator 1020, a memory 1030, an artificial intelligence model module 1040, a storage 1050, and a bus 1060. Although only one processor 1010 is shown in FIG. 13, more than one processors may be provided. The processor 1010, the memory 1030, the artificial intelligence model module 1040, and the storage 1050 may communicate with each other through the bus 1060. In some embodiments, the at least one processor 1010, the memory 1030, the accelerator 1020, and the artificial intelligence model module 1040 may be included in one semiconductor chip. Additionally, in some embodiments, at least two of the at least one processor 1010, the memory 1030, the accelerator 1020, and the artificial intelligence model module 1040 may be provided on two or more semiconductor chips mounted on a board.

The at least one processor 1010 may execute a series of instructions. For example, the at least one processor 1010 may execute instructions stored in the memory 1030 or the storage 1050. The at least one processor 1010 may also load instructions from the memory 1030 or the storage 1050 into internal memory and execute the loaded instructions. In some embodiments, the at least one processor 1010 may perform, by executing the instructions, at least some of the operations described above with reference to the drawings. For example, the at least one processor 1010 may execute an operating system by executing instructions stored in the memory 1030 or may execute applications executed on the operating system.

According to some embodiments, the at least one processor 1010 may instruct the accelerator 1020 and/or the artificial intelligence model module 1040 to perform tasks by executing the instructions, and may obtain a task performance result from the accelerator 1020 and/or the artificial intelligence model module 1040. In some embodiments, the at least one processor 1010 may be an application specific instruction set processor (ASIP) customized for a specific purpose, and may support a dedicated instruction set.

The accelerator 1020 may be designed to perform predefined motions at high speed. For example, the accelerator 1020 may load data stored in the memory 1030 and/or the storage 1050, and store data generated by processing the loaded data in the memory 1030 and the storage 1050. In some embodiments, the accelerator 1020 may perform at least some of the operations described above with reference to the drawings at high speed.

The memory 1030, as a non-transitory storage apparatus, may be accessed through the bus 1060 by the at least one processor 1010. In some embodiments, the memory 1030 may include volatile memory such as dynamic random access memory (DRAM) and static random access memory (SRAM), and may also include non-volatile memory such as flash memory and resistive random access memory (RRAM). In some embodiments, the memory 1030 may store instructions and data for performing at least some of the operations described above with reference to the drawings.

The term “module” used below refers to a software or hardware component such as field programmable gate array (FPGA) or application specific integrated circuit (ASIC), and the “module” performs certain roles. However, the “module” is not limited to software or hardware. The “module” may be configured to be in an addressable storage medium and may be configured to reproduce one or more processors. Thus, as an example, the “module” may include components such as software components, object-oriented software components, class components, and task components, processes, functions, properties, procedures, and may include subroutines, segments of program code, drivers, firmware, microcode, circuitry, data, databases, data structures, tables, arrays, and variables. Functionality provided within the components and “modules” may be combined into a smaller number of components and “modules” or further divided into additional components and “modules”.

The artificial intelligence model module 1040 may infer semiconductor measurement results based on artificial intelligence. The artificial intelligence model module 1040 may use the processor 1010 to store data required for simulation of the artificial intelligence model. Data required for simulation may be stored in the storage 1050. The artificial intelligence model module 1040 may infer the measurement result of all patterns in the semiconductor and infer the expected weak point as a result of the process by inferring the measurement results and outputting the measurement result inference parameter.

The storage 1050 which is a non-transitory storage apparatus may not lose stored data even though power supply is cut off. For example, the storage 1050 may include a semiconductor memory apparatus such as a flash memory, or may include any storage medium such as a magnetic disk or an optical disk. In some embodiments, the storage 1050 may store instructions, programs, and/or data for performing at least some of the operations described above with reference to the drawings.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

As above, embodiments have been disclosed in the drawings and description. Although the embodiments have been described using specific terms in this description, they are only used for the purpose of explaining the technical idea of the present disclosure, and are not used to limit the scope of the present disclosure set forth in the claims.

While the inventive concept has been particularly shown and described with reference to embodiments thereof, it will be understood that various changes in form and details may be made therein without departing from the spirit and scope of the following claims.

What is claimed is:

1. A method comprising:
receiving layout data representing a layout of a semiconductor;
generating a plurality of partial layouts based on the layout data;
selecting a representative partial layout among the plurality of partial layouts; and
generating, using a machine learning model, a predicted measurement result for the semiconductor based on the representative partial layout.

2. The method of claim 1, further comprising:
receiving training data including a sample measurement result and a sample partial layout corresponding to the sample measurement result; and
training the machine learning model to generate the predicted measurement result based on the training data.

3. The method of claim 2, wherein the training of the machine learning model comprises:
encoding the sample measurement result and the sample partial layout to obtain a measurement embedding and a layout embedding, respectively, in a same embedding space; and
computing a loss function based on the measurement embedding and a layout embedding.

4. The method of claim 1, further comprising:
detecting an overlap among the plurality of partial layouts, wherein the representative partial layout is based on the detected overlap.

5. The method of claim 1, wherein:
performing a layout conversion on the representative partial layout, wherein the layout conversion comprises a size conversion, a rotation conversion, or both.

6. The method of claim 1, further comprising:
receiving position data including wafer position data indicating a layout position on a wafer, semiconductor position data indicating a layout position on a semiconductor, or both, wherein the predicted measurement result is based on the position data.

7. The method of claim 1, wherein the predicted measurement result comprises a predicted scanning electron microscope (SEM) image.

8. The method of claim 1, wherein the predicted measurement result comprises a critical dimension risk index.

9. An apparatus comprising:
at least one processor; and
memory configured to store instructions that, when executed by the at least one processor, cause the at least one processor to execute a process of inferring semiconductor measurement results,
wherein the processor is configured to receive layout data representing a layout of a semiconductor,
generate a plurality of partial layouts based on the layout data,
select a representative partial layout among the plurality of partial layouts, and
generate, using a machine learning model, a predicted measurement result for the semiconductor based on the representative partial layout.

10. The apparatus of claim 9,
wherein the processor is configured to:
receive training data including a sample measurement result and a sample partial layout corresponding to the sample measurement result; and
train the machine learning model to generate the predicted measurement result based on the training data.

11. The apparatus of claim 10,
wherein the processor is configured to:
encode the sample measurement result and the sample partial layout to obtain a measurement embedding and a layout embedding, respectively, in a same embedding space; and
compute a loss function based on the measurement embedding and a layout embedding.

12. The apparatus of claim 10,
wherein the processor is configured to:
detect an overlap among the plurality of partial layouts, wherein the representative partial layout is based on the detected overlap.

13. The apparatus of claim 10,
wherein the processor is configured to:
perform a layout conversion on the representative partial layout, wherein the layout conversion comprises a size conversion, a rotation conversion, or both.

14. The apparatus of claim 9,
wherein the processor is configured to:
receive position data including wafer position data indicating a layout position on a wafer, semiconductor position data indicating a layout position on a semiconductor, or both, wherein the predicted measurement result is based on the position data.

15. The apparatus of claim 9,
wherein the apparatus for inferring semiconductor measurement results comprises an inspection apparatus in a semiconductor process control.

16. The apparatus of claim 9,
wherein the apparatus for inferring semiconductor measurement results comprises a review apparatus in a semiconductor process control.

17. The apparatus of claim 9, wherein the predicted measurement result comprises a predicted scanning electron microscope (SEM) image.

18. The apparatus of claim 9, wherein the predicted measurement result comprises a critical dimension risk index.

19. A non-transitory storage medium storing instructions that, when executed by at least one processor, cause the at least one processor to execute a method of inferring semiconductor measurement results, the method comprising:
receiving layout data representing a layout of a semiconductor;
generating a plurality of partial layouts based on the layout data;
selecting a representative partial layout among the plurality of partial layouts; and
generating, using a machine learning model, a predicted measurement result for the semiconductor based on the representative partial layout.

20. The non-transitory storage medium of claim 19, the method comprising:
receiving training data including a sample measurement result and a sample partial layout corresponding to the sample measurement result; and
training the machine learning model to generate the predicted measurement result based on the training data.
